(19) United States
(12) Patent Application Publication
(10) Pub. No.: US 2008/0203726 A1
(43) Pub. Date: Aug. 28, 2008

(54) Data Communication System Embedded In A Fluid Dispensing Line With Limited Travel Swivel

(76) Inventors: David L. Breeser, Minneapolis, MN (US); Gary M. Helleson, St. Louis Park, MN (US)

Correspondence Address: GRACO MINNESOTA INC, PO BOX 1441, MINNEAPOLIS, MN, 55440, US

(21) Appl. No.: 11/996,393

(22) PCT Filed: Jul. 25, 2006
(86) PCT No.: PCT/US06/28827

§ 371 Date: Jan. 22, 2008

Related U.S. Application Data
(60) Provisional application No. 60/703,351, filed on Jul. 28, 2005.

(51) Int. Cl. F16L 27/00; H02G 15/04

(52) U.S. Cl. 285/151.1; 285/153.1

(57) ABSTRACT

The cable hose 30 and hose 20 are designed for use in a system where the handset dispenser 10 is remote from the metering and pumping function. As the user dispenses oil or other fluids, data is transmitted by a communication wire 30 that runs inside the hose 20 that transports the fluid. The power to energize the components is also transmitted through the same wire 30. A swivel 36 is designed for use with this hose 20 and cable 30 so as to limit rotation to less than 360 degrees thereby preventing damage to the cable 30 from excessive twisting. A barbed swivel fitting 38 attaches to the hose 20 and is provided with a partial circumferential groove 40 which extends around the fitting 38 less than 360 degrees and provides a physical barrier preventing rotation beyond the desired amount.

This application claims the benefit of U.S. Application Ser. No. 60/703,351, filed Jul. 28, 2005.

### TECHNICAL FIELD

### Background Art

Distributed fluid dispensing systems such as assignee Graco Inc.'s MATRIX® and HORIZON™ products are known for dispensing fluids such as oils and the like. With such systems, it may be desired to communicate from a dispense meter to a more central location. Such communication has been accomplished with wireless (radio), fiber optic and wiring with the latter two typically being wrapped externally to the fluid line.

### DISCLOSURE OF THE INVENTION

In the instant invention, the cable and hose are designed for use in a system where the handset dispenser is remote from the metering and pumping function. As the user dispenses oil or other fluids, data is transmitted by a communication wire that runs inside the hose that transports the fluid. The measurements are then displayed at a location convenient for the user. The power to energize the components is also transmitted through the same wire.

A swivel is designed for use with this hose and cable so as to limit rotation to less than 360 degrees thereby preventing damage to the cable from excessive twisting. A barbed swivel fitting attaches to the hose and is provided with a partial circumferential groove which extends around the fitting less than 360 degrees and provides a physical barrier preventing rotation beyond the desired amount.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a system using the hose and cable of the instant invention.

FIG. 2 shows a cross-section of the hose and cable of the instant invention.

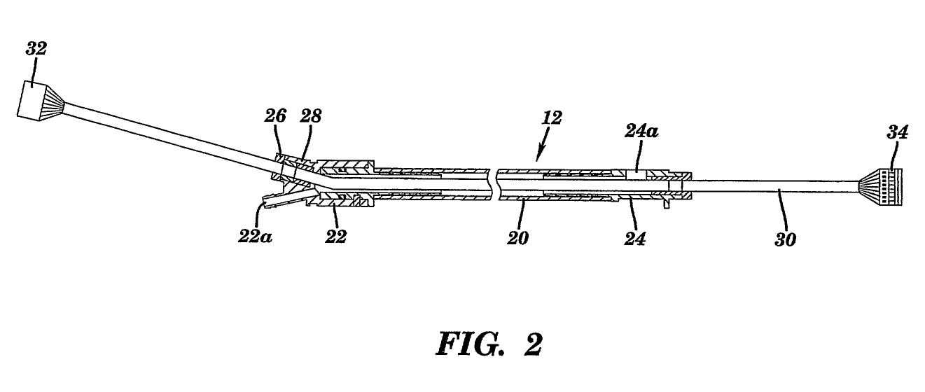

FIG. 3 shows a cross-section of the swivel of the instant invention.

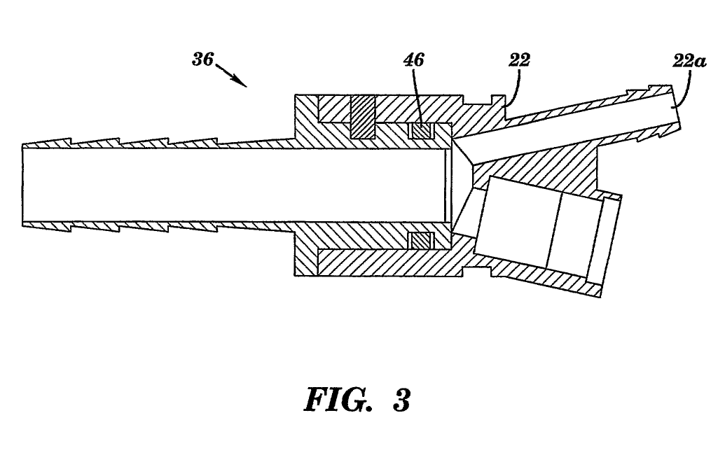

FIG. 4 shows a view of the barbed swivel fitting.

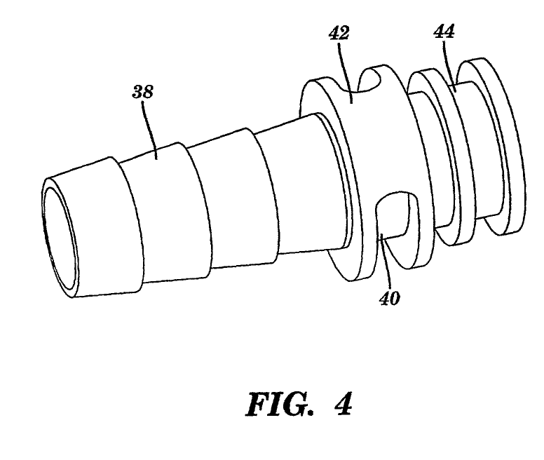

### BEST MODE FOR CARRYING OUT THE INVENTION

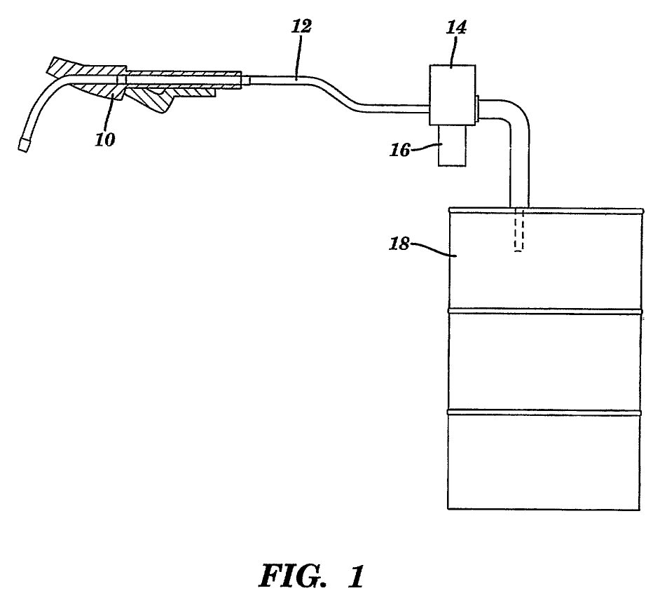

In FIG. 1, a handset dispenser is connected to the end of a fluid line and cable combination 12 which is in turn connected to an electromechanical metering device 14 connected to a pump 16. Pump 16 may in turn be mounted on a fluid reservoir 18.

Hose/cable 12 is comprised of a fluid hose 20 terminated at its ends with manifolds 22 and 24. A wire seal nut 26 and wire seal 28 are provided on manifold 22 for allowing the data cable 30 to exit manifold 22 without fluid leakage. Data cable 30 is provided with termination blocks 32 and 34 for connection to the system. Manifold 22 is provided with a fluid port 22a and manifold 24 has a fluid port 24a.

A swivel 36 is incorporated into manifold 22 for providing limited rotation of the manifold 22 relative to hose 20. Swivel 36 is comprised of a barbed fitting 38 having a partial circumferential groove 40 which extends around the fitting less than 360 degrees (preferably 300 degrees) and provides a physical barrier 42 preventing rotation beyond the desired amount. An o-ring groove 44 is provided for retention of a dynamic o-ring 46 which allows relative rotation. A dowel pin 48 is press fit into manifold 22 and extends into groove 40 along which it is allowed to move until it contacts either end of barrier 42.

It is contemplated that various changes and modifications may be made to the hose/cable without departing from the spirit and scope of the invention as defined by the following claims.

1. A hose and cable combination for use in a fluid dispensing system, the hose and cable combination comprising:
a fluid hose having first and second ends;
a data communication cable extending through said fluid hose;
first and second manifolds at said first and second fluid hose ends, said manifolds each having a seal allowing said data cable to exit without leakage and a fluid port.

2. The hose and cable combination of claim 1 further comprising a swivel on at least one of said manifolds, said swivel allowing rotation of less than 360 degrees.

3. The hose and cable combination of claim 2 wherein said swivel allows rotation of about 300 degrees.

4. The hose and cable combination of claim 2 wherein said swivel comprises
a first member comprising a partial circumferential groove;
a second member rotatable relative to and concentric with said first member and having a pin extending radially toward said first member to engage in said groove; and
a seal located between said members.

5. A swivel for use with a hose and cable combination and comprising:
a first member comprising a partial circumferential groove;
a second member rotatable relative to and concentric with said first member and having a pin extending radially toward said first member to engage in said groove; and
a seal located between said members.
